(19) United States
(12) Patent Application Publication
(10) Pub. No.: US 2026/0259005 A1
(43) Pub. Date: Sep. 3, 2026

(54) Method of heating a steel semi-product in a heating furnace, and associated heating furnace

(71) Applicant: ArcelorMittal, Luxembourg (LU)

(72) Inventors: Jan BAUWENS, Gent (BE); Frederik BLOMMAERT, Gent (BE); Teun Arnoldus Cornelis DE RAAD, Terneuzen (NL); Stefaan DE VLEESCHOUWER, Gent (BE)

(21) Appl. No.: 19/164,783

(22) PCT Filed: Mar. 15, 2024
(86) PCT No.: PCT/IB2024/052530

§ 371 Date: Sep. 12, 2025

(30) Foreign Application Priority Data
Mar. 22, 2023 (WO) PCT/IB2023/052813

(51) Int. Cl. F27B 9/40; C21D 9/00; F23C 1/00; F23N 1/00; F27B 9/02; F27D 17/20; F27D 19/00; F27D 99/00

(52) U.S. Cl. CPC F27B 9/40; C21D 9/0081; F23C 1/00; F23N 1/002; F27B 9/028; F27D 17/20; F27D 19/00; F27D 99/0033; F23N 2235/14; F23N 2235/16; F27D 2019/0018; F27D 2099/0051

(57) ABSTRACT

A method of heating a steel semi-product in a heating furnace, the heating furnace including at least two successive heating sections, the method including feeding the two heating sections with two respective fuel gases flows having respective Wobbe indexes that are different from one another.

The technical field is that of heating methods and furnaces for heating steel semi-products, such a as slabs, blooms, billets or ingots.

### BACKGROUND

In a steel production line, steel semi-products like slabs, blooms or billets, are reheated in a heating furnace before subsequent processing steps, such as hot rolling. Such a heating furnace is typically a walking beam furnace, the steel semi-products being input in the furnace, heated, and then output of it.

To heat the furnace, a fuel gas, for instance natural gas, is supplied to gas burners distributed along the furnace. It is usually desirable that the temperature varies along the furnace, for instance with a temperature that is higher close to an output port of the furnace than close to its input port. So, usually, the heating power released in the furnace varies along the furnace. To this end, the gas burners of the furnace are fed with different flow rates, adjusted by individual valves, depending on the position of the burner along the furnace. Many improvements have been made in recent years to improve the combustion conditions, the heating efficiency, the quality of heating (uniformity across each slab) and the effect on the yield (oxidation of the slabs inside the furnace).

Still, the amount of natural gas, or more generally of light-alkane gas that has to be supplied to heat such a heating furnace remains very high, and it is desirable to reduce this amount.

### SUMMARY OF THE INVENTION

In this context, a method of heating a steel semi-product in a heating furnace is provided. So, instead of employing a same gas (or gas mix) that has a high Wobbe index for all the heating sections and reducing the gas flow-rate for the heating sections that have a lower heating demand, in the method according to the invention, the heating section(s) with a lower heating demand is (are) fed with a gas mix that has a lower Wobbe index than the Wobbe index for the other heating section(s). Gas mixes with different compositions are thus employed, depending on the heating power needed by such or such heating section.

In this method, both the flow rate and the composition of the gas mix may thus be adjusted, which enables a better optimization of the fuel gases consumption of the heating furnace. In particular, thanks to this method, high amounts of steel making exhaust gas (which usually have a rather low heating power) can be used to feed the heating furnace. This is beneficial as steelmaking exhaust gases, like coke oven gas or blast furnace gas, are internal gases, as byproducts of the global steel making process. So, using them on-site, as fuel gases, instead of using an externally supplied fuel gas (like natural gas) reduces the carbon footprint and environmental impact of the heating operation, and more generally of the steelmaking process.

In the method according to the invention, the at least two heating sections of the heating furnace may each be supplied by fuel gases that include: one or more steelmaking exhaust gases, and a supplementing gas, which is a light-alkane gas, dihydrogen or a mix thereof, and wherein the two fuel gases flows, that have different Wobbe indexes, contain respective proportions of the supplementing gas that are different from one another.

The applicant underlines that the method according to the invention, based on a gas mix composition adjustment, is different from a feeding technique in which all the heating sections would be fed with the same gas mix (for instance with the same proportion of the natural gas in this mix) and with a total flow rate varied from one heating section to another, to adjust the heating power released in each heating section.

And it turns out that the amount of supplementing gas required to feed the heating furnace is smaller when the method according to the invention is used, rather than using a constant-composition (and variable flow rate) feeding technique.

This consumption reduction can be explained as follow. When reducing the total amount of gas mix supplied to a given heating section, but keeping its composition constant, the amount of steelmaking exhaust gases supplied to the heating section is reduced. While reducing the proportion of the supplementing gas, the amount of steelmaking exhaust gas supplied to the heating section remains the same, or roughly the same (or even increases); so, the heating power released by the combustion of the steelmaking exhaust gases is higher in the latter case (than when keeping the composition unchanged), and the heating power, that remains to be supplied by the combustion of supplementing gas, is thus smaller, when the composition of the gas mix is adjusted rather than its total flow rate.

Besides, based on calculations predicting the amount of residual NOx produced, no increase in NOx production is expected, with the method according to the invention.

The invention also concerns a heating furnace for heating a steel semi-product (9), the heating furnace comprising at least two successive heating sections (10, 20, 30, 40) and comprising a feeding circuitry (7) arranged to feed the at least two heating sections (10, 20, 30, 40) with at least two respective fuel gases flows (F1, F2, F3, F4) having respective Wobbe indexes (Wob1, Wob2, Wob3, Wob4) that are different from one another.

From a structural point of view, a feeding circuitry arrangement enabling to implement this method may be the following: the feeding circuitry comprises at least:
one or more primary inlets for the one or more steelmaking exhaust gases,
a secondary inlet for a supplementing gas,
a pipe network connecting each of said two heating sections to said primary inlets and to said secondary inlet,
at least two adjustable valves, installed on two pipes of said pipe network that are respectively connected to the two heating sections of the heating furnace, and that transport the supplementing gas unmixed to the one or more steelmaking exhaust gases.

The invention also concerns a heating facility comprising several such heating furnaces, a joint mixing station (105), arranged to mix the steelmaking exhaust gases together to deliver a mixed, composite gas (CG) at an outlet (105.4) of the joint mixing station, and a composite gas supply line (106), connecting the outlet (105.4) of the joint mixing station (105) to the heating sections of the different heating furnaces (1, 1′, 1″) of the heating facility.

### BRIEF DESCRIPTION OF THE DRAWINGS

The invention will now be described in more detail and illustrated by examples without introducing limitations, with reference to the appended figures.

FIG. 1 is a schematic, partial view of a heating furnace according to the invention, seen from the side.

FIG. 2 is a schematic representation of the heating furnace of FIG. 1, seen from above.

FIG. 3 a schematic representation of a heating facility comprising the heating furnace of FIG. 1.

### DETAILED DESCRIPTION

Some general aspects of the invention will be presented first, followed by an embodiment of a heating furnace represented in the figures. Then, the heating method, implemented by this heating furnace, will be described in more details.

As mentioned above, the invention concerns a method, and associated heating furnace, for heating a steel semi-product, the heating furnace comprising at least two successive heating sections, the method comprising feeding said at least two heating sections with at least two respective fuel gases flows having respective Wobbe indexes that are different from one another.

These two Wobbe indexes may have a relative difference of 10% at least, or even of 20% at least. The at least two heating sections, fed with different Wobbe indexes, may each be supplied by fuel gases that include: one or more steelmaking exhaust gases, and a supplementing gas which is a light-alkane gas, dihydrogen or a mix thereof. The two fuel gases flow respectively feeding these two heating sections may then contain different proportions of the supplementing gas, to obtain different Wobbe indexes. Still, it may be noted that different Wobbe indexes may also be obtained by adjusting the proportion of such or such steelmaking exhaust gas (for instance the COG proportion), without adjusting the proportion of the supplementing gas, or even without using a supplementing at all.

By light-alkane gas, it is meant a gas comprising a substantial proportion of a light alkane, or of a mix of light-alkanes. For instance, the light-alkane gas may comprise more than 40% v (that is, a volume proportion, for instance in Normal conditions, higher than 40%) of a light alkane or of a mix of light-alkanes, or more than 50% v or even 70% v or 80% v of a light alkane or of a mix of light-alkanes. By light alkane, it is meant an alkane with one to five, or even one to four Carbon atoms like Methane, Ethane, Propane or Butane. The light-alkane gas may be, for instance, natural gas NG, liquified petroleum gas, propane gas, a biogas or a mix thereof.

Natural gas comprises mainly Methane, with a proportion of Methane typically higher than 80% v, or even higher than 90% v.

A biogas is a renewable energy source that can be obtained by the breakdown of organic matter in the absence of oxygen (or at least in an oxygen-poor environment) inside a closed system called bioreactor. Biogas can be produced from raw materials such as agricultural waste, manure, municipal waste, plant material, sewage, green waste, food waste or any biodegradable materials. Such a biogas may comprise mainly biomethane (with a 40 to 80% v proportion, for instance) and carbon dioxide (15 to 50% v). Other typical biogases main constituents are bio-ethane, bio-propane or bio-butane. When a biogas is employed as a supplementing gas, in the instant method, it may have first been subjected to treatment steps before its use in the reheating furnace, such as a desulphurization, draining out water condensate, or carbon dioxide removal.

By steelmaking exhaust gas, it is meant a gas resulting from any production process in a production unit of a steel making line, the steel making line being considered in its entirety, from crude materials conditioning (ore, coal or scrap conditioning) to finished steel products. In other words, steelmaking exhaust gases are internal gases as a byproduct of the global steel making process. In such a global steel making process, a coke oven plant produces coke from coal and emits a coke oven gas COG, for instance; a blast furnace produces hot metal, or pig iron and emits a blast furnace gas BFG; a basic oxygen furnace, or more generally the steelmaking furnace, produce steel out of hot metal and emits a steelmaking gas BOFG. The steel may also be produced using a direct reduction iron and/or steel scrap melting in an electric arc furnace. So, the steelmaking exhaust gases mentioned above may in particular belong to the following list: coke oven gas, blast furnace gas, basic oxygen furnace gas, direct reduction iron gas, electric arc furnace gas. These gases may have first been subjected to treatment steps before their use in the reheating furnace such as a cooling step and dedusting step. Coke oven gas is also desulphurized, benzol and NH₃ are filtered out and the condensate is drained.

Average compositions of some of these steelmaking exhaust gases are summarized in table 1—compositions being expressed in % v:

TABLE 1

| | CO | CO2 | H2 | H20 | CH4 | N2 |
|---|---|---|---|---|---|---|
| BFG | 19-27 | 15-25 | 1-8 | — | — | 45-60 |
| BOFG | 55-65 | 14-16 | 3-5 | — | 0-1 | 14-16 |
| COG | 3-6 | 1-5 | 36-65 | — | 16-27 | 1-7 |

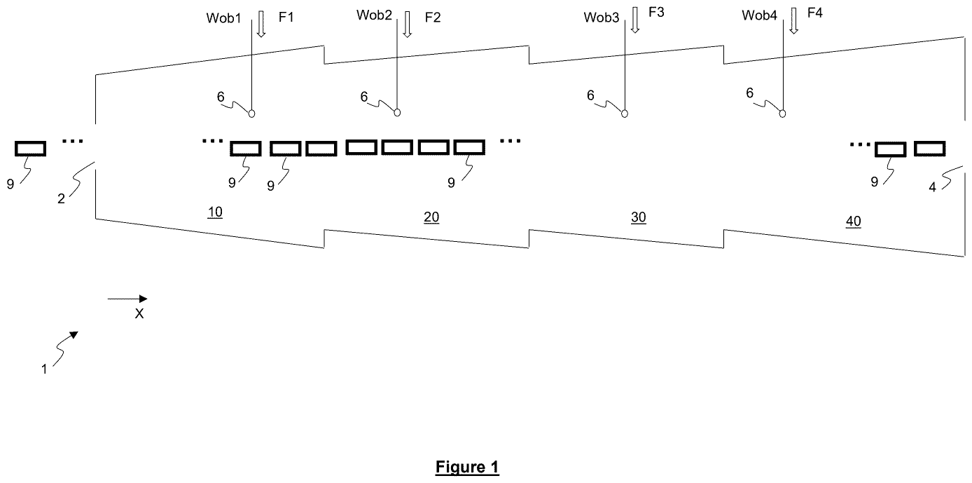

The heating sections of the heating furnace are successive heating zones of the heating furnace, located one after the other. Each heating section comprises one or more gas burners. The heating sections can be separated physically from each other, for instance by constrictions (like in FIG. 1) or baffles, or not (when the heating furnace internal space has a constant section).

Each heating section is fed by a fuel gases flow, dedicated to the heating section considered. The fuel gases flow is the overall, total flux of steelmaking exhaust gas or gases and of light-alkane gas fed to the heating section considered, should these fuel gases be supplied to the heating section already mixed together, or should they be piped to the heating section separately, unmixed (these unmixed fuel gases being then piped respectively to different gas burners of the heating section).

Different types of supplementing gases (for instance natural gas and propane gas) may be used together, to feed one or several of the heating sections. In such a case, the proportion of at least one of these supplementing gases, in the fuel gases flow fed to one of the heating sections, is different from the proportion of that supplementing gas, in the fuel gases flow fed to another of the heating sections.

Regarding the Wobbe index of the fuel gases flow feeding such or such heating section, it is the Wobbe index of the mix of gas feeding that heating section. In other words, it is the Wobbe index of the gas composition of the global, fuel gases flow supplied to that heating section.

For the recall, the lower Wobbe index of a gas (which may be a mix of different gases) is equal to the lower heating value of the gas, per unit volume, in given reference conditions, divided by the square root of the density of the gas relative to air, in the same reference conditions. The refence conditions in question may be, for instance, the Normal conditions (which correspond to a temperature of 273.15 K and a pressure of 101.315 kPa). While the higher Wobbe index of a gas is equal to the higher heating value of the gas, per unit volume, in given reference conditions, divided by the square root of the density of the gas relative to air, in the same reference conditions. In this document, when not specified, the Wobbe index is the lower Wobbe index. The Wobbe Index of the gas mix in question can be measured based on combustion tests, for instance catalytic combustion tests. Such a measurement can be carried on using a commercially available Wobbe index meter, like the RHADOX 7300 model from AMS Analysen-, Mess- und Systemtechnik GmbH or the Hobre WIM Compas Wobbe Index Analyzer model from HMA Instrumentation. The Wobbe Index of the gas mix in question can also be measured based on an optical spectroscopy characterization of the gas mix composition. Such a measurement can be carried on using a commercially available optical Wobbe index meter, like the OMA-206P model by Applied Analytics.

The Wobbe index is an indicator of the interchangeability of fuel gases, it considers both the lower or higher heating values and the specific gravity of the gas and is used to compare the combustion energy output of different compositions of fuel gases. If two fuels have the same Wobbe indexes, their energy output will be the same (variations of +/−5% being allowed) under the same pressure and valve settings. While the calorific value quantifies the heat generated by a fuel, the Wobbe index ensures compatibility and safe interchangeability of different fuel gases, such as the different gas mixtures which can be used in the method according to the invention.

Typical lower Wobbe indexes and lower heating values, for some steelmaking exhaust gases and for natural gas are listed in table 2—the Wobbe indexes and heating values being expressed in MJ/Nm³ (that is in megajoules per cube meter in Normal conditions):

TABLE 2

| | | Lower |
|---|---|---|
| | | heating |
| | Wobbe Index | value |
| BFG mixed with a small amount of BOFG | 3-4 | 3-4 |
| COG | 28-32 | 16-18 |
| natural gas | 45-50 | 38-40 |

A gas mix having a Wobbe Index of 15 may be obtained, for instance, by mixing BFG 50% v, COG 40% v and natural gas 10% v. And a gas mix having a Wobbe Index of 24 may be obtained by mixing BFG 30% v, COG 40% v and natural gas 30% v. Other compositions can be employed, to obtain the same Wobbe indexes, for instance with less BFG, more COG, and less natural gas than in the examples above. The Natural gas content may in particular be adjusted depending on the availability of the COG.

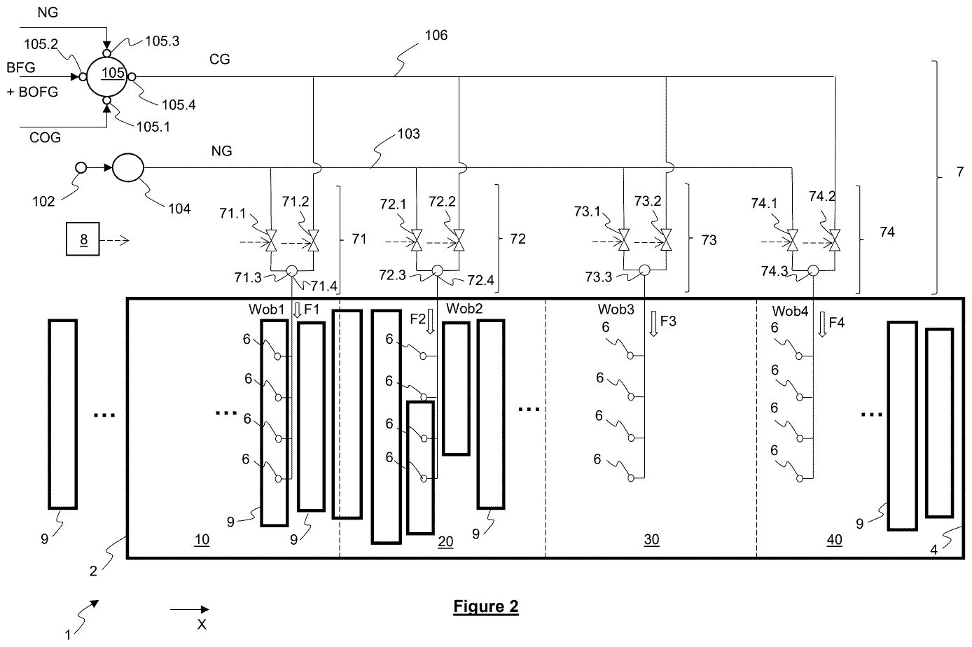

The heating furnace 1, represented in FIGS. 1 and 2 is now described in more detail. The heating furnace 1 is a furnace, for instance a walking beam furnace for reheating steel semi-products 9, like slabs. The steel semi-products could also be billets, brooms or ingots. They can be either long semi-products or flat semi-products. The heating furnace 1 has an input port 2. It has also an output port 4 distinct from the input port. The heating furnace extends, from the input port 2 to the output port 4, along a longitudinal axe X. It comprises several successive heating sections 10, 20, 30, 40 located one after the other along the heating furnace, between the input port 4 and the output port 5. Each heating section 10, 20, 30, 40 comprises gas burners 6. As represented in the figures, the heating furnace 1 comprises four heating sections, 10, 20, 30 and 40. Still, this is for illustrative purposes, and the heating furnace may comprise a different number of successive heating sections, for instance more than five or even more than ten different heating sections. Besides, the heating furnace may comprise a transition, input zone deprived of burners, between the input port and the first heating section.

The heating furnace 1 comprises a feeding circuitry 7, connected to the gas burners 6, and arranged to feed the gas burners 6 with one or more steelmaking exhaust gases and with the supplementing gas. The feeding circuitry 7 is arranged so that each heating section 10, 20, 30, 40 is fed with a corresponding fuel gas flow F1, F2, F3, F4, dedicated to that heating section, and so that at least two of these fuel gases flows have different compositions, in particular different proportions of the supplementing gas. The feeding circuitry 7 is arranged so that these two fuel gases flow have different Wobbe indexes, for instance one above 18 MJ/Nm³, and the other below 16 MJ/Nm³.

The feeding circuitry 7 comprises:
an inlet 102 for the supplementing gas; and
one or more inlets 105.1, 105.2 for the one or more steelmaking exhaust gases.

In the embodiment represented in FIGS. 1 and 2, the supplementing gas is a light-alkane gas, namely natural gas NG, and the one or more steelmaking exhaust gases are coke oven gas COG, blast furnace gas BFG and Basic Oxygen Furnace Gas BOFG. In the embodiment represented in the figures, the COG is input through an individual inlet 105.1 dedicated to that gas, while the BFG and BOFG, already mixed, are input through another individual inlet 105.2. Still, in other embodiments, the steelmaking exhaust gases could be input in the feeding circuitry already all mixed together (and possibly mixed with a bit of light-alkane gas), through a single common inlet.

The feeding circuitry 7 comprises different supply portions 71, 72, 73, 74, dedicated respectively to the different heating sections 10, 20, 30, 40 (FIG. 2). Each supply portion comprises pipes, connected to the burners 6 of the heating section it is dedicated to, and comprises one or several adjustable valves (by adjustable valve, it is meant a valve or a pressure reducer suitable for adjusting a flow gradually, not only in an all-on-all-off manner). Each supply portion 71, 72, 73, 74 is arranged to supply the corresponding heating section 10, 20, 30, 40 with the fuel gases flow F1, F2, F3, F4 dedicated to that heating section.

The feeding circuitry 7 comprises also connecting elements 103, 106 that connect each supply portion 71, 72, 73, 74 with the steelmaking exhaust gases inlets 105.1, 105.2, and that connect at least some of the supply portions 71, 72, 73, 74 with the light-alkane gas inlet 102.

More precisely, each supply portion 71, 72, 73, 74 is connected to a common composite gas distribution line 106, and to a common, light-alkane gas distribution line 103.

The light-alkane gas distribution line 103 is connected to the light-alkane gas inlet 102 through a pressure reducing station 104. The composite gas distribution line 106 is connected to an outlet 105.4 of a mixing station 105, whose inlets comprise the steelmaking exhaust gas inlets 105.1 and 105.2 and comprise also an addition natural gas inlet 105.3. The mixing station 105 outputs a composite gas CG obtained by mixing the steelmaking exhaust gases, supplemented by some natural gas, here.

The feeding circuitry may be arranged, like in the case of FIG. 2, so that the different fuel gases, contained in each fuel gases flow F1, F2, F3, F4, are mixed upstream of the heating section 10, 20, 30, 40, the resulting gas mix being then piped to the gas burners 6 of the heating section.

To this end, each supply portion 71, 72, 73, 74 of the feeding circuitries 7 is arranged, here, to mix the light-alkane gas with the composite gas CG, upstream of the gas burners 6.

The supply portion 71, for instance, comprises:
a valve 71.1, whose inlet is connected to the light-alkane gas distribution line 103 and whose outlet is connected to a mixing element 71.3,
another valve 71.2, whose inlet is connected to the composite gas distribution line 106 and whose outlet is connected to the mixing element 71.3,
the mixing element 71.3 in question, that outputs the fuel gases flow F1 through its outlet 71.4,
pipes, connecting the outlet 71.4 of the mixing element 71.3 and the gas burners 6, for distributing the fuel gases flow F1 to the burners.

In the example of FIG. 2, the other supply portions 72, 73, 74 have the same structure as the supply portion 71.

This kind of upstream-mix arrangement, with the same gas mix supplied to the different burners 6 of the heating section, is beneficial in that it can be implemented with minimal changes on a heating furnace that was previously operating with a single gas mix (having the same composition for all the burners of the furnace) in an adjustable-flow rate but constant-composition mode. Indeed, this upstream mixing arrangement can be implemented in such a furnace by only adding the light-alkane gas supply line 103, the corresponding adjustable valves 71.1-74.1, and the mixing elements 71.3-74.3, with almost no modification of the rest of the pipping system, and, mostly with no modification of the gas burners arrangement in the furnace.

In this regard, the inventors have observed that a type of gas burner, selected for an optimal operation with a fuel gases flow composed of BFG, BOFG, COG and natural gas and having a Wobbe index of 24 MJ/Nm³, for instance, is also adequate for the combustion of a fuel gases flow containing less natural gas, with a Wobbe index as low as 15, or even 10 MJ/Nm³. So, surprisingly, such a gas burner can indeed be fed with fuel gases flow whose natural gas content varies substantially, and the different gas burners 6 of the heating furnace can all be of the same type (which is convenient), with this upstream mixing arrangement.

In the embodiment of FIG. 2, the heating furnace 1 is equipped with an electronic control device 8, comprising at least a processor, a memory, an acquisition module and a communication interface for communicating with the valves 71.1 to 74.1 (and also 71.2 to 74.2), that are electrically controllable valves (that is, electrovalves), here. The electronic control device 8 is configured, for instance programmed, for controlling those valves according to a control method presented below, when describing the method of heating a steel semi-product according to the invention.

In a simplified alternative of the embodiment of FIG. 2, some of the heating sections could be fed with the composite gas only, not with the light-alkane gas. While the other heating sections are fed both with the composite gas and with the light-alkane gas, possibly with a constant proportion of light-alkane gas for all of these other heating sections (in which case the valves 71.1-74.1 may be omitted).

All the components of the feeding circuitry 7 are not necessarily represented in the figures. Indeed, the feeding circuitry may comprise additional, non-represented components, such as valves, regulators, or other safety or distributing components.

Besides, detailed arrangements of the feeding circuitry, different from the one represented in FIGS. 1-2, are possible without departing from the scope of the invention.

In particular, the pipes and valves arrangement of the supply portions 71-74 may differ from the one represented, while still enabling feeding the different heating sections with different Wobbe indexes. For instance, the different gas burners of a same heating section could be fed respectively with different gases, instead of feeding all of them with the same gas mix (produced upstream). When such a “separate piping” arrangement is employed, at least some of the heating sections each comprises several gas burners, and the supplementing gas is then piping, unmixed with the one or more steelmaking exhaust gases, to some of the gas burners dedicated specifically to the supplementing gas, while the one or more steelmaking exhaust gases are piping to the other gas burners of the heating section. In such a case, the fuel gases flow supplied to the heating section is the sum of the supplementing gas flux (supplied to specific, dedicated gas burners) and of the one or more steelmaking exhaust gases flux supplied to the heating section.

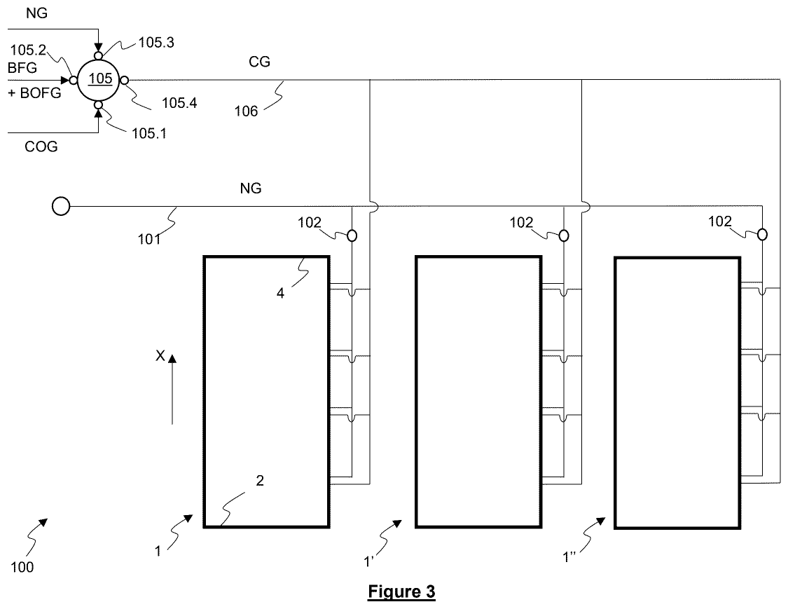

FIG. 3 represents a heating facility 100 comprising several heating furnaces 1, 1′, 1″, among which are the heating furnace 1 of FIGS. 1-2, and two other heating furnaces 1′ and 1″ identical to heating furnace 1.

The supplementing gas inlet 102 of the feeding circuitry 7 of each heating furnace 1, 1′, 1″ is connected to the same global supplementing gas supply line 101.

The heating furnaces 1, 1′, 1″ share the same mixing station 105, where the steelmaking exhaust gases are mixed together (and optionally enriched with a bit of supplementing gas). In other words, the heating facility 100 comprises just one such mixing station, common to the different heating furnaces. The same composite gas supply line 106, connected to the mixing station outlet 105.4, feeds the different heating sections of these heating furnaces 1, 1′, 1″.

In this example, the heating furnaces 1, 1′ and 1″ are identical. Still, they could be different from one another. For instance, the feeding circuitry of one of the heating furnaces may be simpler than for the other heating furnaces and may even be arranged to feed the same gas mix (with the same composition) to all of its heating sections.

The method of heating a steel semi-product in a heating furnace, according to the invention, may be executed using the heating furnace 1 presented above, for instance.

In this method, the steel semi-product 9 is input at the input port 2 of the heating furnace 1, then goes through the successive heating sections 10, 20, 30, 40, to be finally output at the output port 4.

The heating powers, released respectively in the different heating sections 10, 20, 30, 40 of the heating furnace, may be different from each other. For instance, the heating powers released in the last heating sections (close to the output port 4) may be higher than in the first heating sections (close to the input port 2). More generally, the heating powers, released respectively in the different heating sections, are set according to a given, pre-established reheating sequence, to be applied to the steel semi-product.

To obtain these heating powers, the heating sections 10, 20, 30 or 40 are each fed with a fuel gases flow F1, F2, F3 or F4, containing a proportion of the supplementing gas that is adjusted to obtain the required heating power. In particular, for each heating section 10, 20, 30, 40, the proportion of the supplementing gas in the fuel gases flow may be adjusted to obtain, for that flow, a given Wobbe index, set depending on the reheating sequence to be applied to the steel semi-product.

For instance:
Some of the first heating sections (heating section 10 for instance) may be fed respectively by fuel gases flows (F1) with Wobbe indexes (Wob1) lower than 16 MJ/Nm³, for instance equal to 15, or even 12 MJ/Nm³ (or more generally comprised between 4 and 16 MJ/Nm³),
While the other heating sections (heating sections 20, 30 and 40 for instance) are fed by the fuel gases flows (F2, F3, F4) with Wobbe indexes (Wob2, Wob3, Wob4) that are higher than 18 MJ/Nm³, for instance equal to 24 MJ/Nm³ (or more generally comprised between 22 and 40 MJ/Nm³).

In practice, the proportions of the supplementing gas in the different fuel gases flow can be adjusted by controlling the valves 71.1-74.1 mentioned above. This adjustment can be a manual adjustment, for each valve. It can even be a permanent, initial, factory setting (adjusted once and then remaining constant). Still, in the embodiment considered here, the valves 71.1-74.1 are electrically-controllable, and the valves adjustment is carried on by the electronic control device 8.

To this end, the electronic control device 8 may be configured, for instance programmed, in order to execute the following steps:
acquiring heating data representative of a furnace temperature profile, or of a furnace heating power profile, or of a reheating sequence to be applied to a steel semi-product,
for each heating section, determining a target proportion of the supplementing gas, or a target Wobbe index, for the fuel gases flow feeding the heating section considered, based on said heating data (in order to obtain the temperature profile, heating power profile, or reheating sequence in question),
Controlling electrovalves of the feeding circuitry 7, that regulate the fluxes of the fuel gases fed to different heating sections (here the electrovalves 71.1-74.1), based on the target proportions or target Wobbe indexes previously determined.

Besides, a feed-back control may be implemented to regulate the temperature in one or more of the heating sections, by adjusting the proportion of the supplementing gas supplied to the heating section considered. To this end, the electronic control device 8 may be configured (for instance programmed) to execute the following steps:
Measuring a measured temperature in the heating section,
Comparing the measured temperature with a set temperature (specified for instance in the temperature profile data mentioned above), and
Depending on the result of the step of comparing, controlling an electrovalve (71.1, 72.1, 73.1 or 74.1) that controls the proportion of the supplementing gas in the fuel gases flow that feeds said heating section (this control may be achieved using a PI, or PID corrector, for instance).

What is claimed is:

1-16. (canceled)

17: A method of heating a steel semi-product in a heating furnace, the heating furnace comprising at least two successive heating sections, the method comprising:
feeding the at least two successive heating sections with at least two respective fuel gases flows having respective Wobbe indexes different from one another.

18: The method as recited in claim 17 wherein:
one of the Wobbe indexes is lower than 16 MJ/Nm³,
while an other of the Wobbe indexes is higher than 18 MJ/Nm³.

19: The method as recited in claim 17 wherein the heating furnace includes an input port for inputting the steel semi-product to be heated, and an output port for outputting the steel semi-product, and wherein a closer heating section of the heating sections closer to the output port, among the heating sections, is supplied by the fuel gases flow having the highest Wobbe index.

20: The method as recited in claim 17 wherein the at least two successive heating sections are each supplied by fuel gases including:
one or more steelmaking exhaust gases, and
a supplementing gas, which is a light-alkane gas, dihydrogen or a mix thereof,
and wherein the two fuel gases flows having different Wobbe indexes contain respective proportions of the supplementing gas different from one another.

21: The method as recited in claim 20 wherein the at least two fuel gases flows, that have different Wobbe indexes, are each produced by mixing the supplementing gas with the one or more steelmaking exhaust gases upstream of the heating section fed by said fuel gases flow.

22: The method as recited in claim 20 wherein the at least two successive heating sections each comprises several gas burners and wherein
the supplementing gas is piped, unmixed with the one or more steelmaking exhaust gases, to some of the gas burners of the heating section dedicated to the supplementing gas,
while the one or more steelmaking exhaust gases are piped to other gas burners of the heating section,
the fuel gases flow supplied to the heating section being the sum of the supplementing gas flux and of the one or more steelmaking exhaust gases flux supplied to the heating section.

23: The method as recited in claim 20 wherein the supplementing gas is natural gas, a biogas or a mix thereof.

24: The method as recited in claim 20 wherein the supplementing gas is a light-alkane gas and wherein:
the proportion of the light-alkane gas, in a first of the two fuel gases flows, is lower than 10% v, while the proportion of the light-alkane gas, in a second of the two fuel gases flows, is higher than 20% v.

25: The method as recited in claim 20 wherein the steelmaking exhaust gas, or one of the steelmaking exhaust gases belongs to the following list: coke oven gas, blast furnace gas, basic oxygen furnace gas, Electric Arc Furnace Gas, Direct Reduction Iron Gas or a mix thereof.

26: The method as recited in claim 20 wherein an electronic control device executes the following steps:
measuring a measured temperature in one of the heating sections,
comparing the measured temperature with a set temperature, and
depending on the result of the step of comparing, controlling an electrovalve regulating the proportion of the supplementing gas in the fuel gases flow feeding said heating section.

27: The method as recited in claim 17 wherein the steel semi-product is a slab, an ingot, a billet or a bloom.

28: A heating furnace for heating a steel semi-product, the heating furnace comprising:
at least two successive heating sections and comprising a feeding circuitry arranged to feed the at least two heating sections with at least two respective fuel gases flows having respective Wobbe indexes different from one another.

29: The heating furnace as recited in claim 28, wherein the feeding circuitry:
comprises one or more inlets for one or more steelmaking exhaust gases, and an inlet for a supplementing gas which is a light-alkane gas, dihydrogen or a mix thereof, and
is arranged so that the at least two fuel gases flows, supplied respectively to the at least two heating sections, contain respective proportions of the supplementing gas that are different from one another.

30: The heating furnace as recited in claim 29 wherein the feeding circuitry comprises, for each of the two heating sections, a respective adjustable valve, arranged on a pipe in fluidic connection with the heating section considered and transporting the supplementing gas unmixed to the one or more steelmaking exhaust gases.

31: The heating furnace as recited in claim 29, wherein the feeding circuitry comprises, for each heating section, at least one mixing element dedicated to the heating section considered, connected to gas burners of said heating section, and arranged to mix the supplementing gas with the one or more steelmaking exhaust gas upstream of the gas burners of said heating section.

32: A heating facility comprising:
two or more heating furnaces, each as recited in claim 29,
a joint mixing station, arranged to mix the steelmaking exhaust gases together to deliver a mixed, composite gas at an outlet of the joint mixing station, and
a composite gas supply line, connecting the outlet of the joint mixing station to the heating sections of the different heating furnaces of the heating facility.
